(19) United States
(12) Patent Application Publication
(10) Pub. No.: US 2007/0255749 A1
(43) Pub. Date: Nov. 1, 2007

(54) SELECTIVE EXTRACTIONS OF DATA FROM LARGE TRANSIENT DATA SETS

(76) Inventors: Joseph A. Vrba, Clinton, TN (US); Kai T. Bouse, Tellico Plains, TN (US)

Correspondence Address: LUEDEKA, NEELY & GRAHAM, P.C., P O BOX 1871, KNOXVILLE, TN, 37901, US

(21) Appl. No.: 11/380,455

(22) Filed: Apr. 27, 2006

(51) Int. Cl. G06F 7/00

(52) U.S. Cl. 707/103 R

(57) ABSTRACT

A method for extracting, displaying and archiving transient test data is performed by cooperative software applications running on one or more computers, such as a client computer and a server computer. The client sends the server an information request regarding a portion of the transient data. Based on the information request from the client, the server provides a summary of the transient data available for extraction. Using the summary information, a user selects which data is to be extracted and archived. By selectively extracting portions of a large transient data set, the invention conserves memory space, sustains or increases speed of associated computers and networks, and eases the manipulation of extracted data.

### FIELD

This invention relates to the field of test data extraction and viewing. More particularly, this invention relates to a system for extracting selected transient test data for display and archiving.

### BACKGROUND

In manufacturing and other industrial environments, machines are often monitored to detect faults and verify proper operation. For example, a machine's vibration may be continuously monitored and alarms generated if the vibration exceeds a predetermined threshold at some frequency of interest. In some machines temperature and fluid pressures may be monitored. These monitoring systems typically incorporate various types of sensors attached to the monitored machine. These sensors generate signals that are transferred to a computer where they are analyzed and in some cases stored for future reference.

During transient machine events, such as planned startups or unexpected shutdowns due to equipment failure, data from multiple sensors is sampled at high frequency and retained as a continuous, unbroken stream. This data is referred to as transient data. Depending on the machine being monitored and the type of data collected, transient data sets may be quite large. These large data sets are often stored on central server computers and are accessed for viewing and analysis on client computers via a network connection.

In some cases, transient data is stored that allows display of continuous waveforms collected over periods longer than 24 hours. For example, at a sample rate of 5120 Hz, a 24-hour waveform may consist of over 442 million measurements originating from a large number of sensors. Although a data analyst may want to “see” data from all the sensors at one time, it is much more common for a data analyst to want to analyze a particular portion of the overall transient data set. More specifically, it is very common for a data analyst to want to see a specific portion of data from a sensor of interest (or a very limited number of sensor signals) for a specific time period associated with a machine event. Obviously, it would be quite inefficient to transmit and archive 442 million values when only a small fraction of such data is desired for analysis.

What is needed, therefore, is a technique for extracting desired portions of large transient data sets and archiving the extracted data for contemporaneous or later analysis.

### SUMMARY

The above and other needs are met by a method for extracting selected transient data using a server computer, a client computer and a display device associated with the client computer. The transient data includes data associated with a plurality of variables that indicate characteristics of a monitored system, such as a machine or other mechanical system under test. In a preferred embodiment of the invention, the method includes steps of:
(a) inputting a request at the client computer for summary information listing one or more of the plurality of variables for which data is available for extraction;
(b) returning the summary information from the server computer to the client computer for display on the display device, where the contents of the summary information are determined based at least in part on the request for the summary information;
(c) displaying the summary information on the display device;
(d) inputting selection information at the client computer, where the selection information indicates one or more variables to be extracted from the transient data;
(e) inputting range information at the client computer, where the range information indicates a range of data associated with the one or more variables to be extracted;
(f) extracting a portion of the transient data at the server computer, where the extracted portion is based on the selection information and the range information; and
(g) archiving the extracted portion of the transient data on a data storage device.

In a preferred embodiment, the method is performed by cooperative data extraction software applications running on the client computer and the server computer. On the client, a software application forwards a request for a summary of data available for extraction. Based on the forwarded request, a software application on the server computer returns the summary to the display device. In one preferred embodiment, the summary includes a channel list and a tachometer list provided in the form of a data selection dialog box. Using the dialog box, a user may select a start time, an end time, one or more channels for data extraction and one or more tachometers for data extraction. The selections are transferred to the server which extracts the selected data for viewing and archiving. The archived data is preferably stored in separate files—one file for each tachometer and one file for each channel.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a data collection, extraction and analysis system according to a preferred embodiment of the invention;

FIG. 2 depicts a flow chart of a method for selective data extraction according to a preferred embodiment of the invention; and

FIG. 3 depicts a data selection dialog box according to a preferred embodiment of the invention.

### DETAILED DESCRIPTION

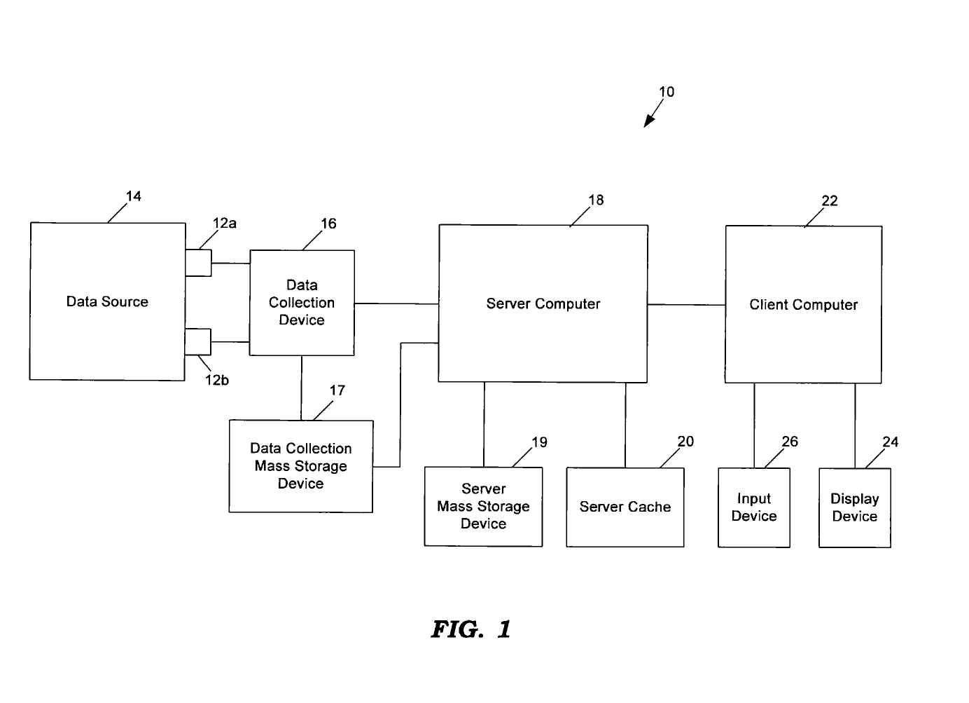

FIG. 1 depicts an example of a system 10 for extracting, displaying, and archiving transient data. In the illustrated system 10, sensors 12a and 12b are attached to a data source 14 (e.g., a machine-under-test) for collecting transient data. For example, the sensors 12a-b may be accelerometers for measuring vibration characteristics of the data source 14. A data collection device 16 receives sensor signals from the sensors 12a-b, conditions the signals, and converts the signals into digital data for temporary storage on an associated local mass storage device 17. An example of such a data collection device is the Model 4500-T manufactured by CSI Technology, Inc. The local mass storage device 17 may be a component of the data collection device 16 or it may be in a separate unit in communication with the data collection device 16.

A server computer 18 accesses transient data from the data collection device 16 or directly from the local mass storage device 17. In preferred embodiments, the server 18 extracts portions of the data and copies the extracted portions to a mass storage device 19 associated with the server 18 for archival. The server 18 preferably includes cache memory 20 for temporary data storage.

In the preferred embodiment shown in FIG. 1, a client computer 22 is connected by a network to the server computer 18. Through the network, the client computer 22 has access to the transient data stored on the data collection device 16. In alternative embodiments, a single computer may perform the functions of the client computer 22 and the server computer 18. Connected to the client computer 22 is a display device 24, such as an LCD, CRT, plasma display, or other similar display on which visual displays of transient data are made available. A user input device 26, such as a mouse, touch pad and/or keyboard, is collected to the client computer 22 for a user to use in inputting commands and information. In the preferred embodiment, the client computer 22 is a desktop computer. However, in other embodiments the client computer may be a laptop computer, handheld computer, PDA, or other similar device known to those skilled in the art.

Connections between components of the network (e.g., client computer 22, server computer 18, and data collection device 16) may be made via a local area network (LAN) or a wide area network (WAN) or both. These connections may be made by network or interface cables, fiber optic cables, wireless connections (such as RF or infrared connections), or any other data connection means known to those skilled in the art. Although the preferred embodiment of the invention is implemented using a separate client computer 22 and server computer 18 connected by a network, other embodiments of the invention are implemented using only one computer.

In a preferred embodiment of the invention, the method of transient data extraction, display, and archiving is performed using cooperative software applications or routines running on the data collection device 16, the server computer 18 and the client computer 22. Using these software applications, the server computer 18 can extract desired transient data from one or more large transient data files, and can archive the extracted transient data on the mass storage device 19. When reference is made herein to the client computer 22, the server computer 18 or the data collection device 16 performing some action, it should be appreciated that the action is preferably performed based on execution of the software applications.

The term “component” as used herein refers to a particular component of interest that may be a sub-part of a larger data source, such as a large complex machine or mechanical system. For example, a “component” may be defined as a particular position along an axis “z” (substantially normal to two-dimensional x-y axes) of a rotating shaft, wherein the particular position of the shaft is monitored at position “Z1” along the shaft based on data related to sensor outputs along axes “x” and “y.” Component “Z1” may, therefore, contain three channels of data including two channels corresponding to two separate position sensors (i.e., a sensor for monitoring movement in the “x” direction and a sensor for monitoring movement in the “y” direction) and one channel corresponding to a tachometer associated with the rotating shaft. The term “component” as defined herein should be interpreted broadly, including the designation of any portion of a monitored source of data wherein at least one channel of data may be extracted and archived. Thus, the definition of “component” includes any number of data channels depending on the complexity of the source of data and the nature of the “component” of interest. Moreover, those skilled in the art will appreciate that the specific examples of “components” given herein are meant to be illustrative only and are not meant to be limiting in any way.

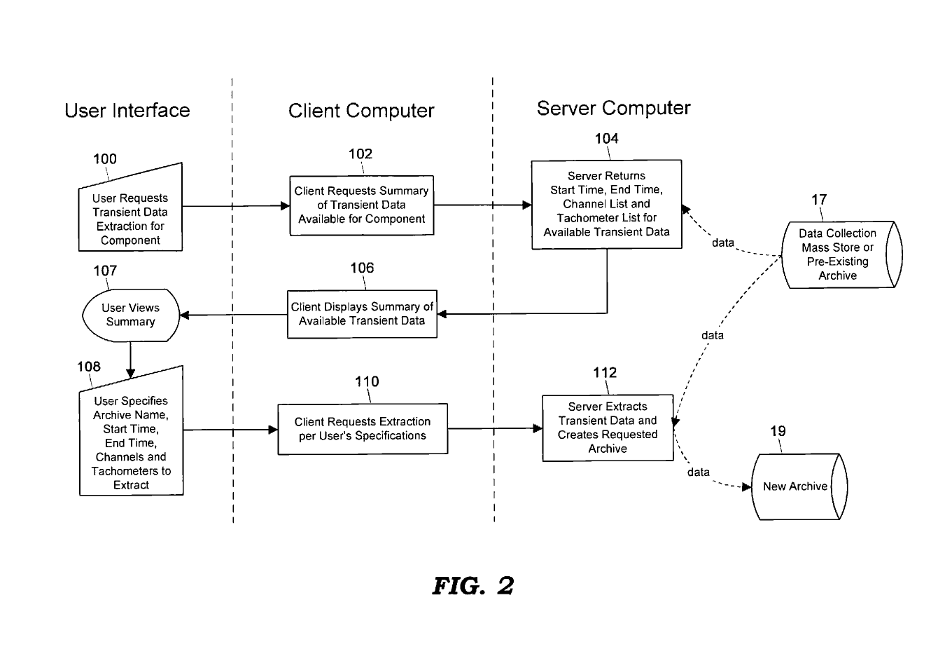

FIG. 2 depicts a preferred method implemented by the software applications on the server computer 18 and the client computer 22 for extracting transient data and archiving the extracted transient data. With reference to FIG. 1 and FIG. 2, at the client computer 22, a user inputs a request for a summary of transient test data available for a component (step 100). The client computer 22 forwards the information request to the server computer 18 (step 102). Upon receiving the forwarded information request, the server computer 18 determines what transient data is available and returns a summary of available data for the component (step 104). The client computer 22 displays the summary on the display device 24 (step 106).

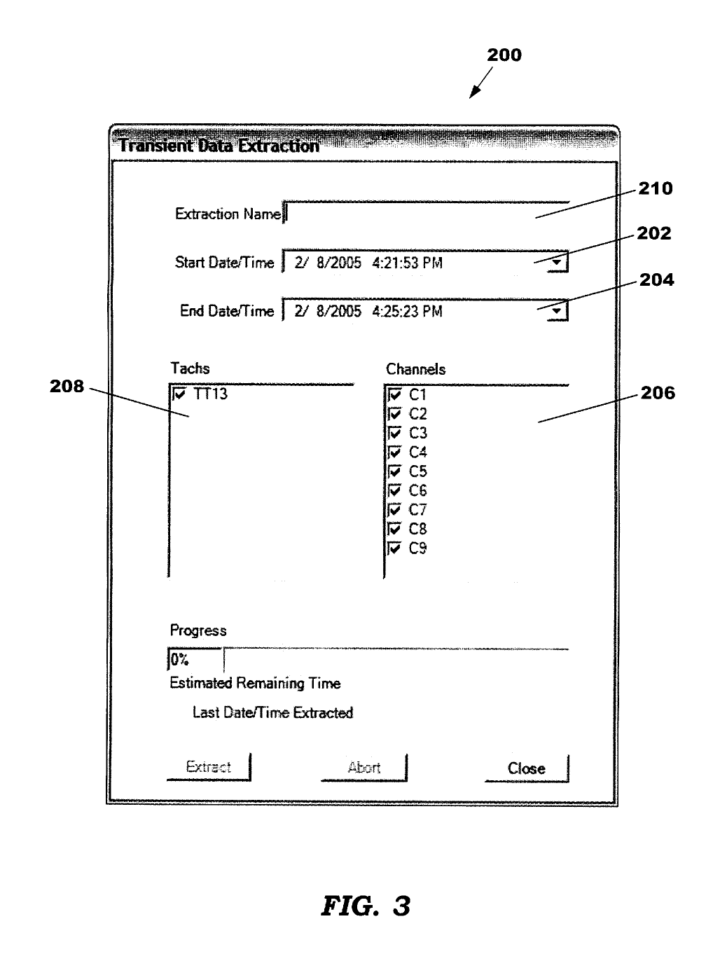

FIG. 3 depicts an example display of a summary of transient data available for a component. The summary of available transient data is preferably displayed in the form of a data selection dialog box 200 that can be closed, minimized, maximized, or selectively moved around within the display area of the display device 24. As shown in FIG. 3, the data selection dialog box 200 of a preferred embodiment includes a channel list 206 and a tachometer list 208 from which the user may choose. A start time 202 and an end time 204 may be input manually using the data selection dialog box 200 to define a time range from which time-corresponding data is to be extracted.

Depending on the manner the information request was entered to the client computer 22, the start time 202 and/or the end time 204 may be filled in prior to the server computer 18 returning the summary of available transient data. For example, in one embodiment of the invention, a user may input an information request by dragging a display screen position indicator, or cursor, across a graphical representation of displayed transient data. More specifically (for example), a pointer on a computer display screen that is responsive to a mouse or other input device may be moved to a portion of a graph of transient data. A user may hold down the left button on the mouse, and drag the mouse (thereby dragging the pointer) across a specific portion of the graphed data. By this action, the highlighted (or “boxed in”) data may be automatically interpreted by one or more software applications as the input information request (step 100) which designates the type of data to be included in the summary of available transient data (e.g., a channel list like list 206 and a tachometer list like list 208) as well as the start time 202 and end time 204.

With reference again to FIG. 2, after viewing the summary of available data provided in the data selection dialog box 200 (step 107), a user selects at least one variable of data, a start time and an end time (if the start time and end time have not previously been selected as described above) (step 108). The term “variable” as used herein refers to a source of data originating from a sensor or group of sensors. For example, with reference to FIG. 3, the term “variable” encompasses a “Channel” such as “C1” or a “Tach” such as “TT13.” The term “variable” also refers to data from other types of sensors or sources, such as accelerometers, temperature sensors, pressure sensors and voltage sensors. Moreover, the term “channel” as used herein refers broadly to any means of transmitting or distributing information in any form known to those skilled in the art. For example, a “variable” may include a data channel through which signals from a light sensor are transmitted. The number of available variables from which a user may select at step 108 is limited only by the data available in the particular application. Therefore, the invention is not limited to any particular number or type of available variables or channels.

After a user enters an extraction request, including a start time, an end time and at least one variable, the client computer 22 transfers the extraction request to the server computer 18 (step 110). In the example data selection dialog box shown in FIG. 3, the extraction request includes an “Extraction Name” 210 for naming the file or files in which the archived data will be saved. Upon receipt of the extraction request, the server computer 18 extracts the requested transient data corresponding to the variable(s) and time range selected by a user, and archives the extracted transient data in the mass storage device 19 or other storage device (step 112). This archival may occur during or after the data extraction. Preferably, the extracting step and archiving step are performed at substantially the same time, as depicted in step 112 of FIG. 2.

In the case of one preferred embodiment shown in FIG. 3, the archiving includes storing tachometer data from “TT13” for the selected time range in a first file, storing data from channel “C1” for the selected time range in a second file, storing data from channel “C2” for the selected time range in a third file, and so on. Thus, in this embodiment of the invention, all of the data corresponding to each individual variable are preferably archived in separate files corresponding to the identity of each variable.

One of the benefits of the various embodiments of the invention described herein is the ability to extract, transfer, and/or archive only a particular portion of a large transient data set that is desired for analysis. Many transient data sets are very large and cumbersome to transfer through a network to or from a mass storage device. Moreover, the transfer of such large data sets tends to slow down the performance of the associated computers and/or networks. By selectively extracting portions of a large transient data set, the present invention offers many benefits including, but not limited to, (1) increased conservation of memory storage space, (2) sustained or increased performance speed of associated computers and/or networks, and (3) increased ease of actively analyzing extracted data (e.g., manipulating into statistical graphs or other figures).

In the preferred embodiment of the invention, transient data is stored on the data collection device 16 prior to extraction. However, in other embodiments, transient data may be stored on the mass storage device 17 or other mass storage means separate from the data collection device 16. For example, mass storage devices may be utilized that are physically distant from the data extraction device 16. For example, mass storage means may be located hundreds of miles away and connected via a virtual private network (VPN) connection or other network connection known to those skilled in the art.

In the preferred embodiment, data requested by a user via an extraction request is selectively extracted from the data collection device 16 and made available on the server 18. The extracted data is then made available to the client computer 22 for a user to display on the display device 24. The extracted data may be temporarily stored in the server cache 20 on the server computer 18. However, any means of data storage known to those skilled in the art may be used. In the preferred embodiment, extracted data is archived on a mass storage device 19 associated with the server 18. However, extracted data may be archived on any storage device associated with the system 10, such as on the client computer 22 or on a storage device operatively connected to the system 10 via a network.

In one embodiment of the invention, the data collection device 16 is programmable to automatically extract test data from the transient data storage device 17 when a specific condition or event occurs during operation of a machine under test 14 which may indicate a problem with the machine 14. An example of a specific condition or event would be an accelerometer or tachometer reading going over a predetermined threshold for a predetermined time period. Preferably, the time range of the automatically extracted data starts at a fixed time before the event and continues through a specific time after the event. During an automatic data extraction, all sensor data associated with the machine under test 14 are extracted, since an analyst would typically not have pre-existing knowledge of what caused the problem.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application. and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for extracting selected transient data using a computer and a display device associated with the computer, wherein the transient data includes data associated with a plurality of variables that are indicative of characteristics of a monitored system, the method comprising steps of:
(a) displaying summary information on the display device, the summary information listing one or more of the plurality of variables for which data is available for extraction;
(b) inputting selection information indicating at least one variable from the plurality of variables to be extracted;
(c) inputting range information indicating a range of data associated with the at least one variable to be extracted;
(d) extracting a portion of the transient data based on the selection information and the range information; and
(e) archiving the extracted portion of the transient data.

2. The method of claim 1 further comprising:
(f) prior to step (a), inputting a request for the summary information; and
(g) prior to step (a), returning the summary information for display on the display device, wherein the contents of the summary information are determined based at least in part on the request for the summary information.

3. The method of claim 2 wherein step (f) comprises dragging a display screen position indicator across a graphical representation of the transient data displayed on the display device, thereby indicating a portion of the transient data of interest.

4. The method of claim 1 wherein the summary information includes a list of available data collection channels from which the transient data was collected.

5. The method of claim 1 wherein the summary information includes a list of available data collection devices from which the transient data was collected.

6. The method of claim 1 wherein step (c) further comprises inputting a start time and an end time for the range of transient data.

7. The method of claim 1 wherein step (a) comprises displaying the summary information in a data selection dialog box on the display device.

8. The method of claim 1 wherein step (e) comprises saving the extracted portion of the transient data in a plurality of data files, wherein each data file is associated with a corresponding one of the selected variables.

9. The method of claim 1 wherein step (e) further comprises specifying an archive name to be associated with one or more data files containing the archived portion of the transient data.

10. The method of claim 1 wherein
step (d) comprises extracting the portion of the transient data from a first data storage device; and
step (e) comprises archiving the extracted portion of the transient data on a second data storage device.

11. A method for extracting selected transient data using a server computer, a client computer and a display device associated with the client computer, wherein the transient data includes data associated with a plurality of variables that are indicative of characteristics of a monitored system, the method comprising steps of:
(a) inputting at the client computer a request for summary information listing one or more of the plurality of variables for which data is available for extraction;
(b) returning the summary information from the server computer for display on the display device, wherein the contents of the summary information are determined based at least in part on the request for the summary information;
(c) displaying the summary information on the display device;
(d) inputting selection information at the client computer, the selection information indicating at least one variable from the plurality of variables to be extracted;
(e) inputting range information at the client computer, the range information indicating a range of data associated with the at least one variable to be extracted
(f) extracting a portion of the transient data at the server computer, the extracted portion based on the selection information and the range information; and
(g) archiving the extracted portion of the transient data.

12. The method of claim 11 wherein the summary information includes a list of available data collection channels from which the transient data was collected.

13. The method of claim 11 wherein the summary information includes a list of available data collection devices from which the transient data was collected.

14. The method of claim 11 wherein step (a) comprises dragging a display screen position indicator across a graphical representation of the transient data displayed on the display device, thereby indicating a portion of the transient data of interest.

15. The method of claim 11 wherein step (e) further comprises inputting a start time and an end time for the range of transient data.

16. The method of claim 11 wherein step (c) comprises displaying the summary information in a data selection dialog box on the display device.

17. The method of claim 11 wherein step (g) comprises saving the extracted portion of the transient data in a plurality of data files, wherein each data file is associated with a corresponding one of the selected variables.

18. The method of claim 11 wherein step (g) further comprises specifying an archive name to be associated with one or more data files containing the archived portion of the transient data.

19. The method of claim 11 wherein
step (f) comprises extracting the portion of the transient data from a first data storage device; and
step (g) comprises archiving the extracted portion of the transient data on a second data storage device.

20. A method for extracting selected transient data using a server computer, a client computer and a display device associated with the client computer, wherein the transient data includes data associated with a plurality of variables that are indicative of characteristics of a monitored system, the method comprising steps of:
(a) inputting a request for summary information at the client computer by dragging a display screen position indicator across a graphical representation of a portion of the transient data displayed on the display device;
(b) returning the summary information from the server computer for display on the display device, wherein the summary information includes a list of available data collection channels from which the portion of transient data was collected and a list of available data collection devices from which the portion of transient data was collected;
(c) displaying the summary information on the display device;
(d) inputting selection information at the client computer, the selection information indicating at least one variable to be extracted from the transient data;
(e) inputting at the client computer a start time and an end time to designate a range of transient data associated with the at least one variable to be extracted
(f) extracting a portion of the transient data at the server computer, the extracted portion based on the selection information and the range information; and
(g) archiving the extracted portion of the transient data.

21. An apparatus for extracting and archiving selected transient data, wherein the transient data includes data associated with a plurality of variables that are indicative of characteristics of a monitored system, the apparatus comprising:
means for inputting a request for summary information, wherein the summary information indicates one or more of the plurality of variables for which data is available for extraction;
means for displaying the summary information for viewing by a user;
means for inputting selection information to designate at least one of the plurality of variables to be extracted from the transient data;
means for inputting range information indicating a range of data associated with the at least one variable to be extracted;
means for extracting a portion of the transient data based at least in part on the selection information and the range information; and
means for archiving the extracted portion of the transient data.

22. A computer-implemented method for extracting selected transient data from a data storage device, wherein the transient data includes data associated with a plurality of variables that are indicative of characteristics of a monitored system, the method comprising steps of:
(a) collecting transient data associated with one or more of the plurality of variables;
(b) storing the transient data on the data storage device:
(c) continuously monitoring the transient data to determine whether a fault-related event has occurred during operation of the monitored system:
(d) when the transient data indicates a fault-related event has occurred during operation of the monitored system, determining a time range of the transient data to be extracted, where the time range is determined based at least in part on a time at which the fault-related event occurred;
(e) extracting from the data storage device a portion of the transient data collected during the time range; and
(f) storing the extracted portion of the transient data for analysis.
